(19) United States
(12) Patent Application Publication
(10) Pub. No.: US 2026/0283907 A1
(43) Pub. Date: Sep. 24, 2026

(54) Medication Storage and Tracking Device

(71) Applicant: John Kuhns, Colorado Springs, CO (US)

(72) Inventor: John Kuhns, Colorado Springs, CO (US)

(21) Appl. No.: 19/379,842

(22) Filed: Nov. 5, 2025

Related U.S. Application Data
(60) Provisional application No. 63/774,842, filed on Mar. 20, 2025.

(51) Int. Cl. A61J 7/04; A61J 7/00

(52) U.S. Cl. CPC A61J 7/04; A61J 7/0069; A61J 2205/20; A61J 2205/50

(57) ABSTRACT

A medication storage and tracking device is provided. The device is comprised of at least one pill container, a dry erase surface, and a dry erase marker. In one embodiment, the device comprises seven pill containers corresponding to the days of the week, while alternative embodiments comprise twenty-eight, thirty, or thirty-one containers for monthly usage. Each container may include an internal divider to separate time-based doses and may be labeled with customizable indicia such as text, color codes, or tactile elements. The containers may also include lids with closures and locking mechanisms for secure storage. The containers are affixed to a dry-erase surface constructed from materials suitable for repeated use, which includes user-interface elements for time tracking, daily logging, and freeform annotations. A dry erase marker is retained in an integrated fastener and the surface may include a raised perimeter lip to temporarily hold loose pills.

### CROSS REFERENCE TO RELATED APPLICATION

The present application claims priority to, and the benefit of, U.S. Provisional Application No. 63/774,842, which was filed on Mar. 20, 2025, and is incorporated herein by reference in its entirety.

### FIELD OF THE INVENTION

The present invention relates generally to the field of medication organizing and tracking. More specifically, the present invention relates to a device for organizing and securely storing daily or monthly medications using labeled pill containers affixed to a reusable dry erase surface such that the device supports customizable scheduling, tracking, and annotation of medication intake to enhance user adherence and reduce dosing errors. Accordingly, the present disclosure makes specific reference thereto. Nonetheless, it is to be appreciated that aspects of the present invention are also equally applicable to other like applications, devices, and methods of manufacture.

### BACKGROUND

The administration of medications at prescribed intervals is critical for the efficacy and safety of treatment regimens, particularly for individuals managing multiple prescriptions. Patients who must take several medications at different times of day often face challenges in maintaining accurate dosing schedules. These challenges can lead to missed or incorrect doses, compromising the effectiveness of the medications and increasing the risk of adverse health outcomes. Memory aids such as audible alarms or digital reminders may not always be sufficient, particularly for users with cognitive impairments, inconsistent daily routines, or distractions during alert times. Physical medication organizers address some of these challenges but often lack integrated tracking features, leaving room for confusion or error. Additionally, written tracking methods such as paper logs may be easily misplaced or ignored, limiting their utility. There is a need for a more integrated system that not only provides structured medication storage but also facilitates real-time visual tracking and user interaction. A comprehensive approach that combines physical organization with erasable recording surfaces would offer a reusable, flexible solution to address medication adherence and dosage tracking concerns.

Therefore, there exists a long-felt need in the art for a medication storage and tracking device that improves adherence to medication schedules through a visual and interactive system. There also exists a long-felt need in the art for a medication storage and tracking device that allows flexible organization and labeling of medications for daily or monthly use. Moreover, there exists a long-felt need in the art for a medication storage and tracking device that enables users to record, update, and verify medication intake data in a reusable format.

The subject matter disclosed and claimed herein, in one embodiment thereof, comprises a medication storage and tracking device. The device is comprised of at least one pill container, a dry erase surface, and a dry erase marker. In one embodiment, the device comprises seven pill containers corresponding to the days of the week, while alternative embodiments comprise twenty-eight, thirty, or thirty-one containers for monthly usage. The pill containers may have various geometric configurations and be arranged in spatial layouts such as linear, radial, or grid-based arrays. Each container may include an internal divider to separate time-based doses and may be labeled with customizable indicia such as text, color codes, or tactile elements. The containers may also include lids with closures and locking mechanisms for secure storage. The containers are affixed to a dry-erase surface constructed from materials suitable for repeated use, which includes user-interface elements for time tracking, daily logging, and freeform annotations. A dry erase marker is retained in an integrated fastener and the surface may include a raised perimeter lip to temporarily hold loose pills. The device may also include a mounting interface with mechanisms such as adhesive pads or magnetic strips for installation on various surfaces.

In this manner, the medication storage and tracking device of the present invention accomplishes all the foregoing objectives and provides a medication organizer with a reusable dry erase system that enables users to actively track and manage their daily or monthly medication intake, wherein the configuration of labeled pill containers and the customizable annotation interface directly support adherence to complex dosing schedules. The secure lids and labeling features further mitigate the risk of accidental dosing errors, while the raised perimeter and mounting options increase functionality in home and clinical settings. This combined functionality addresses the limitations of traditional organizers and standalone reminder systems by offering a cohesive, interactive, and adaptable solution to promote accurate and consistent medication usage.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a medication storage and tracking device. The device is designed to aid users in organizing and managing daily intake of medications, supplements, and other ingestible regimens, while providing an integrated mechanism for recording and tracking usage to support adherence, prevent dosing errors, and maintain a reusable interface for activity logging.

The device is comprised of at least one pill container. In some embodiments, the device is comprised of seven pill containers corresponding to days of the week, while alternative embodiments may include 28, 30, or 31 containers to accommodate various scheduling needs. Each container may be comprised of at least one internal divider to segment contents for distinct intake times, such as morning and evening. Each pill container may also be comprised of labeling indicia including textual, tactile, visual, or modular elements such as slide-in tabs or magnetic labels to enable customization for changing user requirements. Each container may be further comprised of a lid with closure mechanisms that may include snap-fit, hinged, twist-lock, or magnetic designs. Some lids may also be comprised of locking mechanisms such as child-resistant latches or slide-lock actuators to prevent unauthorized access.

The pill containers may be affixed to a dry-erase surface that may be flat or contoured and constructed from erasable materials. The surface may be further comprised of user-interface elements including time-of-day rows, tracking rows for daily adherence, and annotation sections for custom user entries such as dosage notes or timestamps. The layout of these elements may vary in format. The device may be further comprised of a dry erase marker, which may be retained by a fastener. The dry erase surface may also be comprised of a raised perimeter lip, designed to temporarily retain loose pills or tablets to prevent spillage during sorting or preparation. The device may also be comprised of a mounting interface with at least one attachment mechanism.

A method of using the device includes providing a configuration of the device with at least one pill container, a dry erase surface, a marker, and a mounting interface. Medications are then organized into containers according to a schedule, with optional application of labeling indicia. The user then annotates relevant information using the marker. The marker is stored in the fastener when not in use. Loose pills may further be placed on the surface within the perimeter lip for sorting prior to placement in containers.

Accordingly, the medication storage and tracking device of the present invention is particularly advantageous as it provides a medication organizer with a reusable dry erase system that enables users to actively track and manage their daily or monthly medication intake, wherein the configuration of labeled pill containers and the customizable annotation interface directly support adherence to complex dosing schedules. The secure lids and labeling features further mitigate the risk of accidental dosing errors, while the raised perimeter and mounting options increase functionality in home and clinical settings. This combined functionality addresses the limitations of traditional organizers and standalone reminder systems by offering a cohesive, interactive, and adaptable solution to promote accurate and consistent medication usage.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a medication storage and tracking device of the present invention in accordance with the disclosed architecture;

FIG. 2 illustrates a top view of one potential embodiment of a medication storage and tracking device of the present invention in accordance with the disclosed architecture; and

FIG. 3 illustrates a flowchart of a method of using one potential embodiment of a medication storage and tracking device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a medication storage and tracking device that improves adherence to medication schedules through a visual and interactive system. There also exists a long-felt need in the art for a medication storage and tracking device that allows flexible organization and labeling of medications for daily or monthly use. Moreover, there exists a long-felt need in the art for a medication storage and tracking device that enables users to record, update, and verify medication intake data in a reusable format.

The present invention, in one exemplary embodiment, is comprised of a medication storage and tracking device. The device facilitates user organization and management of daily intake of medications, supplements, and other ingestible regimens. Additionally, the device integrates a system for recording and tracking usage, thereby promoting adherence, minimizing dosing errors, and supporting activity monitoring through a reusable interface.

The device is comprised of at least one pill container. In certain embodiments, seven pill containers are provided that are each corresponding to a day of the week. Alternative embodiments may feature 28, 30, or 31 containers to accommodate varying scheduling requirements. Each pill container may be comprised of at least one internal divider to separate contents by specific intake times, such as morning and evening. Labeling indicia may also be included, which may comprise textual, tactile, visual, or modular formats like slide-in tabs or magnetic labels to enable user-specific customization. Each container may be comprised of a lid featuring closure mechanisms such as snap-fit, hinged, twist-lock, or magnetic types. Certain lids may also include locking mechanisms, such as child-resistant latches or slide-lock actuators, to enhance safety and prevent unauthorized access.

The pill containers may be mounted onto a dry erase surface, which may be either flat or contoured and constructed from materials that support erasability. This surface may be comprised of user-interface elements including rows for time-of-day indications, tracking sections for daily adherence, and customizable annotation areas for user entries such as dosage notes or timestamps. The spatial arrangement of these elements may vary. A dry-erase marker may be included with the device and secured using a fastener. The dry erase surface may also be comprised of a raised perimeter lip to temporarily retain loose pills or tablets and prevent them from spilling during preparation. Additionally, the device may be comprised of a mounting interface with one or more attachment mechanisms.

A method of using the device involves configuring it with at least one pill container, a dry erase surface, a marker, and a mounting interface. Medications are sorted into containers based on a predetermined schedule, with optional application of labeling indicia. The user may then annotate relevant data on the dry erase surface using the marker, which is subsequently stored in the fastener. Loose pills may be placed temporarily within the perimeter lip for sorting before being transferred to the containers.

As a result, the device offers distinct advantages by providing an integrated medication organizer with a reusable dry erase interface, enabling users to actively manage and monitor daily or monthly medication intake. The configuration of labeled containers combined with a customizable annotation system supports complex dosing adherence. The secure lids and adaptable labeling further reduce the potential for accidental errors, while the raised perimeter and mounting capabilities enhance usability across residential and clinical environments. Therefore, the device effectively overcomes the limitations of traditional organizers and standalone reminder systems by promoting accuracy and consistency in medication management.

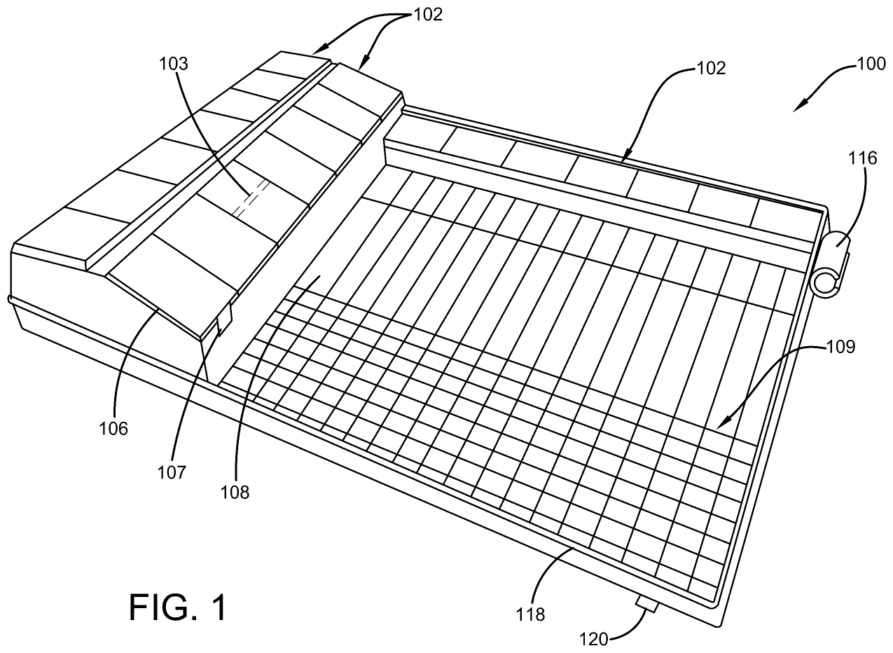

Referring initially to the drawings, FIG. 1 illustrates a perspective view of one potential embodiment of a medication storage and tracking device 100 of the present invention in accordance with the disclosed architecture. The device 100 is designed to assist users in organizing and managing their daily intake of medications, supplements, and other ingestible regimens while providing an integrated device for recording and tracking usage of the same. As a result, the device supports adherence to prescribed medication schedules, reduces the risk of missed or duplicated doses, and maintains a visible, reusable interface for recording medication activity.

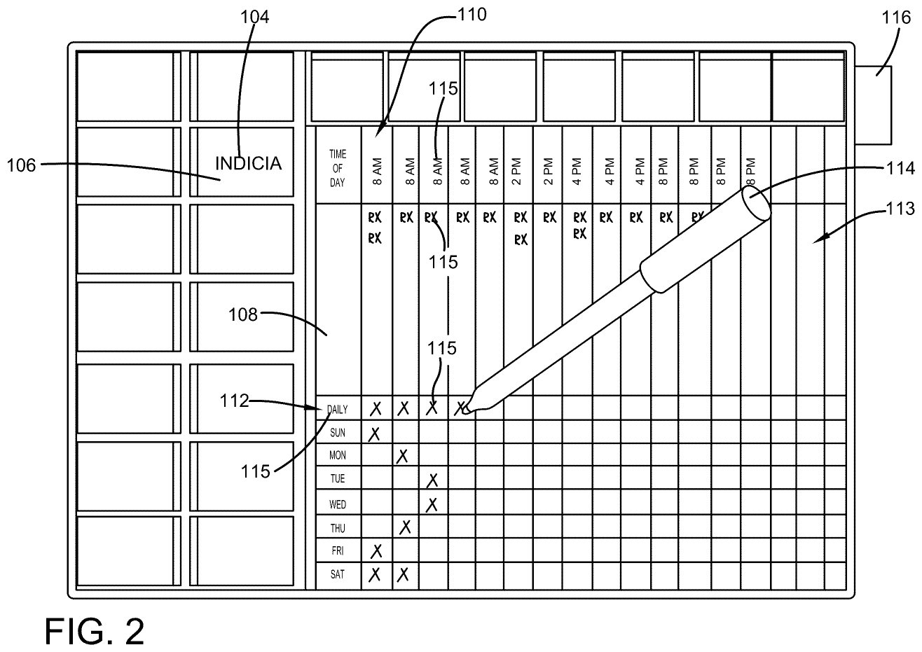

The device 100 is comprised of at least one pill container 102, as seen in FIG. 1 and FIG. 2. In one embodiment, the device 100 is comprised of seven pill containers 102, each corresponding to a day of the week such as but not limited to Monday through Sunday. In alternative embodiments, the device 100 may be comprised of 30 or 31 pill containers 102 to support comprehensive monthly medication planning or may be comprised of 28 pill containers 102 for alignment with standard monthly cycles.

Each pill container 102 may be configured in any geometric shape including but not limited to cylindrical, cuboidal, oval, polygonal, or mixed-form configurations. The pill containers 102 may be arranged in various spatial formats such as but not limited to linear alignment, circular or radial symmetry, grid-based arrays, staggered orientations, etc. The volume, height, depth, and internal cross-section of each container 102 may be varied to accommodate different medication dosages, pill sizes, and compartmentalization needs. In one embodiment, each pill container 102 may be comprised of at least one internal divider 103. The internal divider 103 may partition the interior volume of the container 102 into two or more compartments, for morning and evening intake.

Each pill container 102 may be comprised of labeling indicia 104, as seen in FIG. 2, which may include but are not limited to text, markings, tactile indicators, raised pictograms, Braille, visual markers such as color-coding, etc. In some embodiments, the labeling indicia 104 may be implemented in a modular or replaceable format in the form of but not limited to slide-in tabs, rotatable day wheels, magnetic tiles, or peel-and-stick labels to allow for user customization and adaptability to changing schedules.

Each container 102 may be further comprised of a lid 106, as seen in FIG. 1 and FIG. 2. The lid 106 may be but is not limited to snap-fit closures, hinged flaps, twist-lock mechanisms, magnetically sealed covers, slidable panels, etc. In some embodiments, the lid 106 may be further comprised of a locking mechanism 107. The locking mechanism 107 may include but is not limited to a child-resistant latch, a push-and-twist interface, a slide-lock actuator, a magnetic release latch, etc. to prevent accidental access or tampering.

The pill containers 102 may be affixed to a dry erase surface 108. The dry erase surface 108 may be planar, concave, convex, etc. The surface 108 may be constructed from materials such as but not limited to melamine-faced panels, acrylic sheets, polypropylene-laminate boards, PET films, or tempered safety glass to support erasability and repeated marking cycles. The dry erase surface 108 may be further comprised of multiple user-interface elements 109. The elements 109 may include but are not limited to a row for indicating time-of-day 110 such as morning, afternoon, and evening; rows for frequency or daily tracking 112 such as individually labeled weekday slots or date indicators; and multiple blank annotation sections 113, as seen in FIG. 2. The blank sections 113 may support user-entered data 115 (as seen in FIG. 2) such as dosage notations, timestamps, confirmation checkmarks, user initials, reminder symbols, times of day, day of week, frequency, prescription name, etc. The spatial configuration of user-interface elements 109 may be linear, radial, columnar, modular, etc.

The device 100 may be further comprised of a dry erase marker 114. The dry erase marker 114 may be retained by a fastener 116. The fastener 116 may be comprised of a molded clip, integrated docking cradle, magnetic strip, elastic retaining loop, adhesive-backed holder, etc. that secures the marker 114 when not in use.

The dry erase surface 108 may be further comprised of a raised perimeter lip 118. The raised perimeter lip 118 may extend upward from the surface 108 by a height sufficient to temporarily retain loose pills or tablets placed on the surface 108 for sorting, preparation, or visual review, reducing the risk of roll-off or spillage.

The device 100 may also be comprised of a mounting interface 120, as seen in FIG. 1, to facilitate installation on vertical or horizontal surfaces. The mounting interface 120 may be comprised of at least one attachment mechanism such as but not limited to removable adhesive pads, suction cups, keyhole brackets, screw-mounted hooks, magnetic backings, hook and loop strips, etc. As a result, the attachment mechanism 120 may allow the device 100 to be mounted to surfaces including walls, cabinets, refrigerators, doors, medical trolleys, etc.

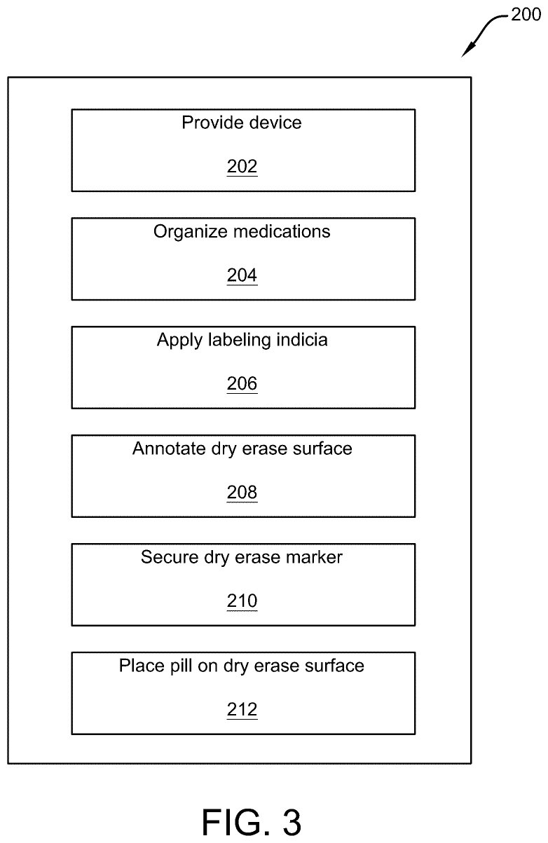

The present invention is also comprised of a method of using 200 the device 100, as seen in FIG. 3. First, a device 100 is provided comprised of at least one pill container 102, at least one dry erase surface 108, at least one dry erase marker 114, and at least one mounting interface 120 [Step 202]. Then, a user can organize medications or supplements into the pill containers 102 according to a preferred schedule, wherein each container 102 may correspond to a day of the week, a specific date, or a specific time of day as needed [Step 204]. Optionally, the user can apply labeling indicia 104 (in a removable/reconfigurable embodiment) to each pill container 102, wherein the labeling indicia 104 may be fixed or replaceable and may include text, tactile markers, or color-coded symbols for user reference [Step 206]. Subsequently, the user may utilize the dry erase marker 114 to annotate the user-interface elements 109 on the dry erase surface 108, including entering time-of-day indicators 110, tracking frequencies 112, and custom data 115 into annotation sections 113 [Step 208]. The user can then secure the dry erase marker 114 into the fastener 116 when not in use [Step 210]. Loose pills or tablets may be temporarily placed within the raised perimeter lip 118 on the dry erase surface 108 for sorting or review prior to container placement [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “medication storage and tracking device” and “device” are interchangeable and refer to the medication storage and tracking device 100 of the present invention.

Notwithstanding the foregoing, the medication storage and tracking device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the medication storage and tracking device 100 as shown in the FIGS. are for illustrative purposes only, and that many other sizes and shapes of the medication storage and tracking device 100 are well within the scope of the present disclosure. Although the dimensions of the medication storage and tracking device 100 are important design parameters for user convenience, the medication storage and tracking device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A medication storage and tracking device comprising:
a dry-erase marker;
a dry erase surface comprised of a fastener for retaining the dry erase marker, the dry erase surface comprised of a user-interface element; and
a pill container attached to the dry erase surface, the pill container comprised of a lid.

2. The medication storage and tracking device of claim 1, wherein the user-interface element is comprised of a time-of-day row.

3. The medication storage and tracking device of claim 1, wherein the user-interface element is comprised of a frequency-tracking row.

4. The medication storage and tracking device of claim 1, wherein the lid is comprised of a locking mechanism.

5. The medication storage and tracking device of claim 1, wherein the pill container is comprised of an internal divider.

6. The medication storage and tracking device of claim 1, wherein the pill container or the lid is comprised of an indicia.

7. The medication storage and tracking device of claim 1, wherein the indicia is comprised of a text, a marking, a tactile indicator, a raised pictogram, a braille, or a color-coding.

8. The medication storage and tracking device of claim 1, wherein the dry erase surface is comprised of a blank annotation section.

9. A medication storage and tracking device comprising:
a dry-erase marker;
a dry erase surface comprised of a row, a blank section, a perimeter lip, and a fastener for retaining the dry erase marker; and
a pill container attached to the dry erase surface, the pill container comprised of a lid.

10. The medication storage and tracking device of claim 9, wherein the perimeter lip extends upward from the dry erase surface.

11. The medication storage and tracking device of claim 9, wherein the fastener is comprised of a clip, a docking cradle, a magnetic strip, an elastic loop, or an adhesive-backed holder.

12. The medication storage and tracking device of claim 9 further comprised of a mounting interface.

13. The medication storage and tracking device of claim 12, wherein the mounting interface is comprised of a removable adhesive pad, a suction cup, a keyhole bracket, a screw-mounted hook, a magnetic backing, or a hook and loop strip.

14. The medication storage and tracking device of claim 9, wherein the user-interface element is comprised of a time-of-day row.

15. The medication storage and tracking device of claim 9, wherein the user-interface element is comprised of a frequency-tracking row.

16. The medication storage and tracking device of claim 9, wherein the lid is comprised of a locking mechanism.

17. The medication storage and tracking device of claim 9, wherein the pill container is comprised of an internal divider.

18. The medication storage and tracking device of claim 9, wherein the pill container or the lid is comprised of an indicia.

19. The medication storage and tracking device of claim 9, wherein the indicia is comprised of a text, a marking, a tactile indicator, a raised pictogram, a braille, or a color-coding.

20. A method of using a medication storage and tracking device, the method comprising the following steps:
providing a medication storage and tracking device comprised of a dry erase marker, a dry erase surface, and a pill container comprised of a lid;
organizing a medication or a supplement into the pill container; and
annotating the dry-erase surface using the dry-erase marker.
